(19) United States
(12) Patent Application Publication
(10) Pub. No.: US 2006/0173829 A1
(43) Pub. Date: Aug. 3, 2006

(54) Embedded translation-enhanced search

(76) Inventor: Yoni M. Neeman, Herzlia (IL)

Correspondence Address: DICKSTEIN SHAPIRO MORIN & OSHINSKY LLP, 2101 L Street, NW, Washington, DC, 20037, US

(21) Appl. No.: 11/328,153

(22) Filed: Jan. 10, 2006

Related U.S. Application Data
(60) Provisional application No. 60/642,115, filed on Jan. 10, 2005.

(51) Int. Cl. G06F 17/30

(52) U.S. Cl. 707/3

(57) ABSTRACT

A model for a search engine or content subscription system that includes hidden layer of embedded translations for the words and phrases that occur in a search result page, and automatic insertion of such hidden layer of embedded translations to all content that is linked to from the result page. The hidden layer contains translations of all words and phrases on the search results from the original language of the document to any given language, or to several given languages. Embedded translations that are in the hidden layer of the search results become overt when a user actively requests to see them, per given word or phrase, using any activation method. Translations are inserted by a computer program that comprises of lexicons, morphological rules, and context rules for morphological disambiguation. Capabilities adhering to multi-language content and multi-language users are added to search engines for web content or enterprise content.

### FIELD OF THE INVENTION

The invention relates to the field of language translation and, in particular, a search engine or content subscription system having hidden translations for the words and phrases that occur in a search result page.

### BACKGROUND

As the Internet spreads globally, the situation where an Internet user searches for content that is not in his or her native language is becoming more and more common. The same phenomenon occurs in enterprise content, which often comprises documents in several languages, and whose users are speakers of different languages.

Searching for content on the Internet that is of relevance to the user has become a commonplace, daily activity. A search for content may be carried out by actively querying web search engines or enterprise search engines, i.e. entering a query string, scanning the results, and following the links in an attempt to reach the content of interest; or a search for content can be carried out by subscribing to content providers that provide content to the user in a push mode, e.g., a user can use an RSS reader, receive RSS feeds from selected sources and interest areas, scan the RSS results and follow the links to the content of interest.

Serving the search results or subscription items fully translated to the user's native language would be optimal in this multilingual search situation. However, software or computer-based engines offering a full-page machine translation (such as Babelfish (http://babelfish.altavista.com/) and Systran (http://www.systransoft.com/) still cannot produce accurate and reliable results. Semantic ambiguity is one barrier to machine translation, morphological ambiguity is another barrier, and further barriers are the result of the special nature and complexity of human languages, such as idioms or reference to newly coined phrases, and the dependency of language understanding on real world knowledge. There is a large amount of evidence that fully-automatic, high-quality machine translation is impractical (beginning with Bar Hillel's work in the 1950's, showing that high quality machine translation was not attainable in principle (Y. Bar Hillel (1960), “The Present Status of Automatic Translation of Languages” in: Advances in Computers, VI, 91-163) and more recently, see, for example, Alan K. Melby (1995) “Why Can't a Computer Translate More Like a Person?” in: Translation, Theory and Technology, 1995 Barker Lecture, http://www.ttt.org/theory/barker.html)

Some results produced by machine translation can have meanings that are very far from the original language of the text. Often, the user that looks at an entire page that was translated to another language, is not aware of the lack of consistency with the original text, or cannot understand the meaning of the translated text at all, as illustrated in FIG. 1. FIG. 1 is a screenshot of machine translation performed by Babelfish.

Therefore, it is desirable to have a search engine or content subscription system that produces a separate file containing a context-sensitive translation of the content of the search results or subscription items, without dispensing of the original text. Such a system would allow a user to have context-sensitive translations of portions of search results from the search engine, or subscription items from the content subscription system. The translation is shown so that the user will still be able to see the original text. As a result, the user obtains a better idea of what information is available from various links, even when linked and described in a foreign language, without having to load the translation software onto that user's computer.

### SUMMARY AND OBJECTS OF THE INVENTION

The above-noted deficiencies are overcome with a search engine or content subscription system that includes a hidden layer of embedded translations for the words and phrases that occur in a search result page, and automatic insertion of the hidden layer of embedded translations to all content that is linked to/from the result page. The hidden layer contains translations of all words and phrases in the search results from the original or overt language of the document to any given language, or to several given languages. Embedded translations that are in the hidden layer of the search results become overt (i.e., displayed) when a user actively requests to see them, per given word or phrase, using a mouse action, a key combination, a touch on the screen, or any other activation method. Translations are inserted automatically by a computer program that comprises of lexicons, morphological rules, and context rules for morphological disambiguation. Thus capabilities adhering to multi-language content and multi-language users are added to search engines, whether for web content or enterprise content.

### BRIEF DESCRIPTION OF THE DRAWINGS

FIG. 1 is a screenshot of a prior art machine translation;

FIG. 2 is a graphical representation of a page according to the present invention;

FIG. 3 is a graphical representation of an information retrieval system according to an embodiment of the present invention;

FIG. 4 is a graphical representation of an information retrieval system according to another embodiment of the present invention;

FIG. 5 is a screenshot of a results page according to the present invention;

FIG. 6 is a screenshot of a website having an RSS reader according to the present invention;

FIG. 7 is a flowchart illustrating the process flow of the present invention;

FIG. 8 is a sample of HTML document source data according to an embodiment of the present invention;

FIG. 9 is a sample of HTML document source data according to another embodiment of the present invention;

FIG. 10 is a sample of RTF document source data according to another embodiment of the present invention; and

FIG. 11 is a screenshot of another embodiment of the present invention.

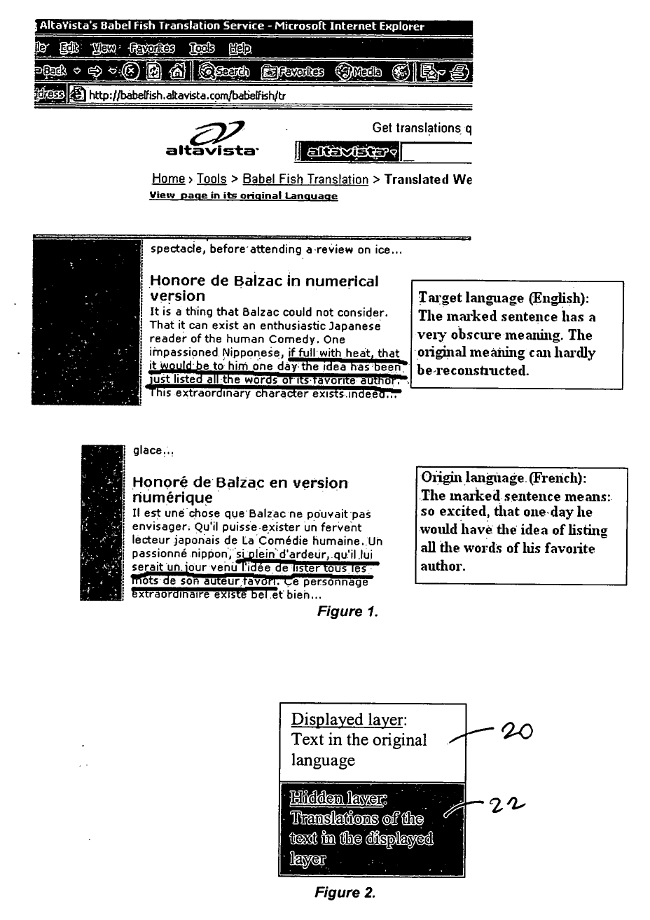

### DETAILED DESCRIPTION OF THE INVENTION

In embedded translation-enhanced search (ETES), both the primary results of the search engine or the RSS feed summaries, and all pages linked to from these results, are shown to the user in their original language and original format, but contain a sub-layer of translation. Each word (or in some cases a phrase) in the visible layer of this document has, associated with it, its appropriate translation in this hidden layer. In order to see this translation, the reader of the document has, at his or her disposal, an operating means responsive to the reader's selection of a portion of the visible text layer for exposing a portion of the invisible layer over the corresponding portion of the visible layer. The layer is activated many ways, including, but not limited to hovering, clicking, or double-clicking a mouse over the visible portion, touching it with an electronic pen, touching it with a finger using a touch-sensitive display screen, using vocal commands (voice activated), or pointing to it using joystick.

ETES employs a computer program that creates translations of the words that occur in it from the original language to any other target language or languages. However, ETES can be implemented as part of a hardware component such as a logic/memory semiconductor device. Because the input to ETES is continuous text, and not one word at a time, the translations may contain the following improvements over simple dictionary lookup results:
1. The input words are analyzed morphologically; i.e. all inflections are recognized, and not just headwords (e.g. Spanish inflections, such as “Hablo” (I speak) may be translated to English, not just headwords such as “Hablar”).
2. The input words are morphologically disambiguated; e.g. “will” as a noun receives a different translation from “will” as an auxiliary verb.
3. The translated words are morphologically synthesized, e.g. “houses” is translated into Spanish as “casas”.

When the user asks for the translation, using one of the above described operation means, the translation is displayed, e.g. in a small pop-up window, at the bottom of the screen, or on any other location and means of display.

Because the translations are already there in the search result, as an underlying layer, no additional special-purpose translation program needs to be installed and/or invoked to display the translation; and no additional action needs to be taken by the user, such as submitting the page to any form of translation engine. A graphical representation of a page served by the server is shown in FIG. 2. The page 20 served by the search server appears by default without the translations, and the translation 22 is shown only when the user requests it; otherwise the original search result is shown without the translations. The means for display either uses existing functionality such as the tooltip function of HTML files, or a script that occurs in the data file itself. Unlike clickable dictionaries, such as “Babylon (http://www.babylon.com/)”, no client application is required for invoking translations of the words that appear in the original text of ETESs.

It is worthwhile to emphasize the distinction between ETES and conventional dictionary applications such as Babylon, Gurunet, or iFinger. These applications need to be activated again and again each time a user wishes to view a translation of a word. Upon activation, the local applications send a specific word or a phrase to be translated (the dictionary data is found either locally on the client or on a web server, but the application is local). By contrast, an ETES server will create the page with the translation layer already included in the search results.

It is also worthwhile to differentiate between ETES and special purpose services, where the user has to actively submit a page by either entering its URL or copying and pasting text, and the service adds popup hints to the URL or text entered. These hints are not actually attached to each word, but rather, a small subset of a lexicon or dictionary is added to the page returned.

Such services may be found in:
http://www.popjisyo.com/WebHint/Portal.aspx
http://www.rikai.com/perl/Home.pl

ETES, by contrast, is not a special purpose service to add partial hints to texts; it is an application with a search function where automatic translation is part of the search service. No active request has to be carried out by the user; from the moment a search query is entered, all search results include a full word by word translation to the user's language. Moreover, since the above sites are based on a small subset lexicon, they do not contain the above mentioned benefits of dealing with continuous texts: the popups are not related to context, and the same word will always have the same popup, unlike ETES; and they do not contain morphological translations of words; so they are quite far from a concept of embedded layer of translation especially tailored to each specific text.

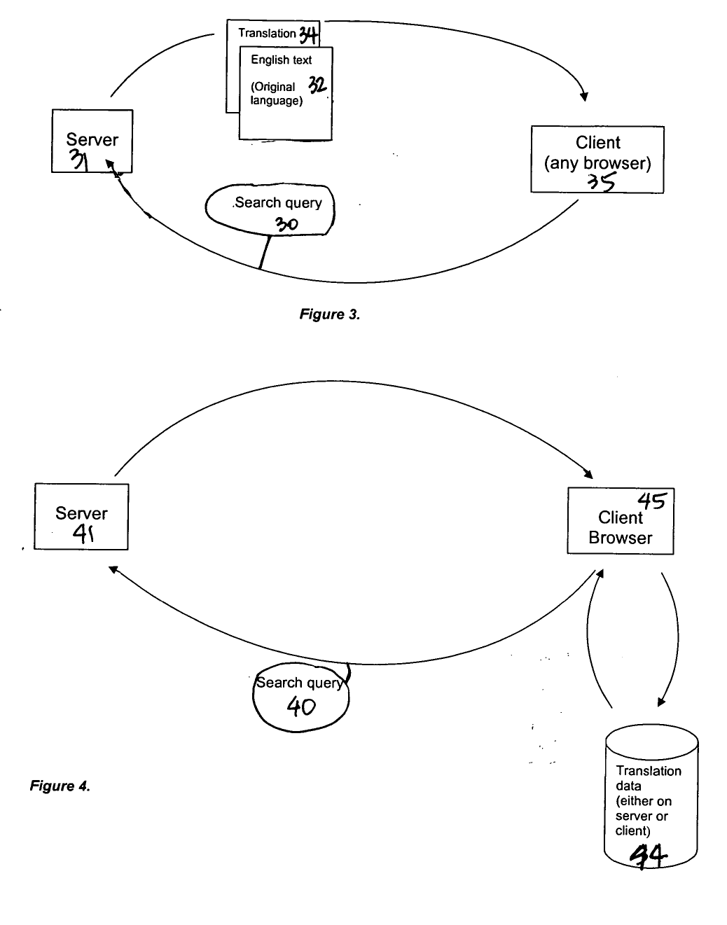

Turning now to FIG. 3, which is a graphical representation of an exemplary information retrieval system using ETES, a query 30 is sent to the server 31. Results 32 are automatically processed once for translation, including embedding in a hidden translation layer 34 before being returned to the client 35.

FIG. 4 is a graphical representation of another exemplary Information retrieval system using a per-word translation application, for example a search and dictionary lookup using a client dictionary program. In this example, the translation data 44 is retrieved multiple times using client application 45. A query 40 is sent to the server 41. Results are processed multiple times to request per-word translations using the client application 35.

The translated language is typically the user's native language, as it is defined in the search engine's preferences. Hence the user does not have to define the language to be translated to for each word, or for each page. The search result page contains the embedded translations to the language defined once by the user, and each search result page is accompanied by a link that includes the embedded translation.

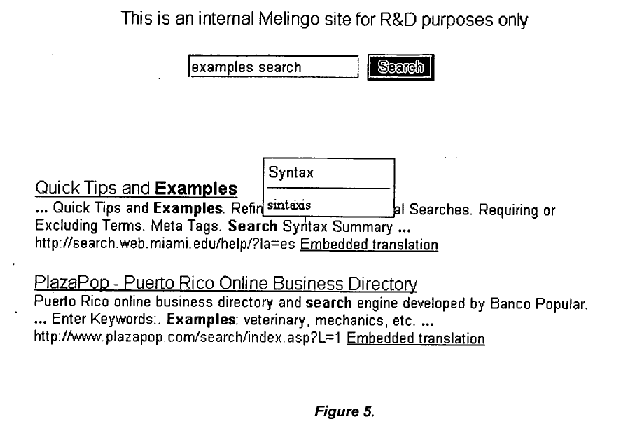

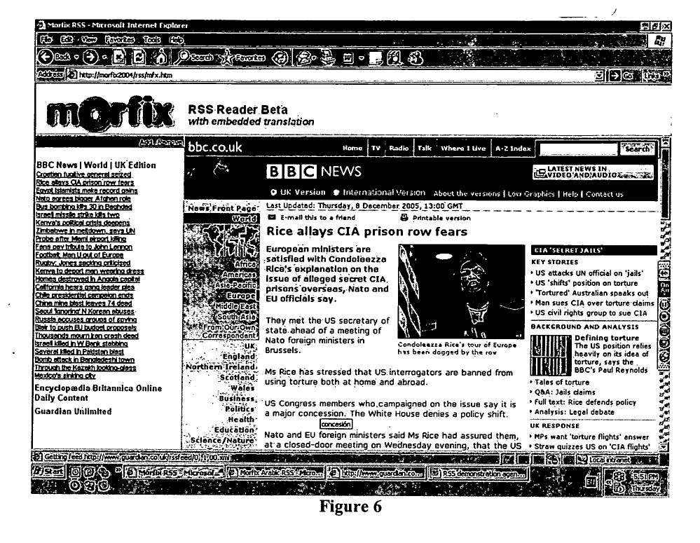

For example, FIG. 5 is a screenshot of a results page shown by a search server. The user has hovered the mouse over the word “syntax”, and hence the translation of this word to Spanish is brought up from the embedded layer to the foreground. Each search result has an alternative link to a version of the same page that is identical to the original page except for having the embedded layer of translation.

Another exemplary implementation of ETES is shown in FIG. 6. FIG. 6 is a screenshot of a website having an RSS reader. There is a range RSS readers available, as discussed further at http://news.bbc.co.uk/2/hi/help/3223484.stm. Shown in the left-hand column of the screen are headlines of items contained in the RSS feeds that the user has chosen. Shown in the right-hand frame of the screen is an article which is linked to the second item from the top (“Rice allays CIA prison row fears”). The RSS feed undergoes embedded translation, so that when the mouse hovers over any word on the article, its translation is shown. In FIG. 6, the English word “concession” is shown with its translation to Spanish, following a mouse hovering action by the user.

Only when the user activates the embedded translation per given word, the translation is brought up and displayed (see FIGS. 5 and 6). This model enables the user to read the page in its original language, and get an immediate translation for any word that appears in the page. Unlike automatic machine translation services (MT), which attempt to translate a whole page from its original language to another language, in the ETES model, the original language of the text is kept intact, and the translation is added on a per-word or per-phrase basis, only as a hidden layer. It is believed that for a person who has some knowledge of the original language of the text, even if it is very limited, this method provides a more credible manner to fully use search results that are not in his or her native language.

ETES gives the user access to both the original and target language; thus in situations where the reader has some knowledge of the original language, he or she may use this knowledge to understand a major part of the text, and consult the embedded translations only when needed. An additional benefit of ETES over MT is that it is not confined to supplying a single target language translation per given source-language word. In other words, a certain amount of ambiguity may be retained in the translation. For example consider a document with original text in English, where the following sentence appears: “the inspectors are looking for arms”. In an ETES document with a Spanish translation layer, the word arms will be translated as “brazos, armas”. Thus the reader of the sentence will be able to deduce that in this context, “armas” is the appropriate translation. A machine translated document, by contrast, is very likely to inappropriately choose the wrong translation, “brazos” in this case (i.e. arms in the body-part sense), and leave the reader with totally incomprehensible Spanish translation text.

Methods for Creating ETESs

The method of creating an ETES is implemented automatically by a computer program applied by the search service provider.

A computer program for creating ETESs should contain the following processes (in this example we refer to the HTML file format, as a private case of a digital file format that contains text):
1. Receive from a search engine a search result buffer or a page linked from the search results; or receives from an RSS feed the XML content, or a page linked to/from the XML content
2. Parse the input buffer, and identify the strings in it that are words (and not format tags, directives, or numbers).

Example:

<HR align=left width=570>

<UL>Ne me quitte pas<BR>

Only the words “Ne me quitte pas” (which mean “Do not leave me”) need to be translated.
3. Send each word and its context to a bilingual dictionary and receive a translation for it*.

E.g.: Spanish: amo la musica=English: I love

Spanish El amo de la case=English: owner, landlord
4. Insert a target language translation of a word or phrase, next to this word or phrase, using a format that will make this translation invisible in the default display of this page, but associated to the original word and available for display in case it is triggered by the user.

Example:

<span title=“The”>El</span>

<span title=“owner, landlord”>amo</span>

<span title=“of”>de</span>

<span title=“the”>la</span>

<span title=“house”>casa</span>
5. Send the page with its underlying invisible translations to the user.

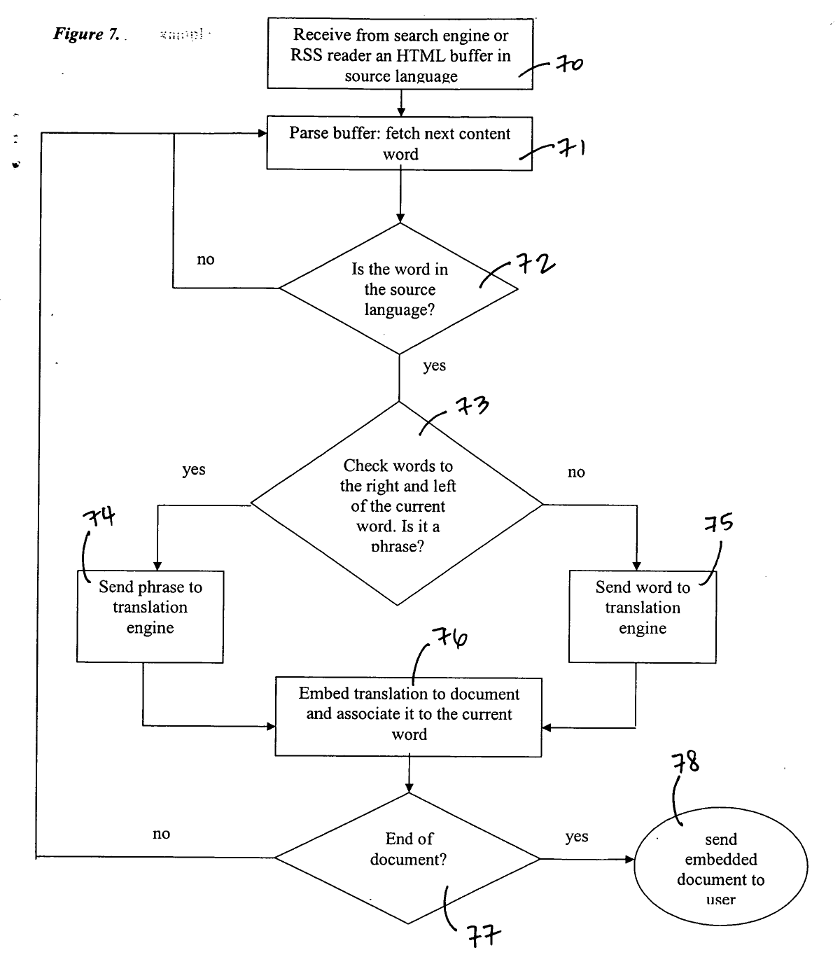

FIG. 7 is a flow chart illustrating an exemplary ETES process where embedded translation is created. In step 70, a user receives an HTML buffer in a source language from a search engine or RSS reader. In step 71, the input buffer is parsed and the next content word is fetched. The application determines whether the word is in the source language in step 72. If it is not, it is returned to step 71 to parse the input buffer and fetch the next content word. If it is, the application checks words adjacent to the current word to determine whether it is part of a phrase, as shown in step 73. If it is, the whole phrase is sent to a phrase translation engine 74. If it is not, the current word is sent to a word translation engine 75. The translated words are then embedded and associated with the current word in the original language in step 76. If it is not at the end of the document, the application returns to parse the input buffer and fetch the next content word. If it is at the end of the document, it sends the entire embedded document to the user, as shown in step 78.

ETES and Different File Formats

Search engines and RSS feeds do not return only HTML documents. ETES may be manifested in several other formats, such as word processor documents and PDF files. The ETES model is not confined to a specific file format, but rather, it applies to any file that is used for displaying text, and may be contained in as a result by a search engine, where an underlying layer is enabled. Thus, the ETES model is applicable, in addition to HTML and its extensions, to any conventionally known word processor formats such as Microsoft Word Doc, Word Perfect, AppleWorks, RTF, PDF documents, etc. The ETES manifestation can be viewed by respective conventional viewers for these formats, including, but not limited to, Microsoft Internet Explorer and Netscape Mozilla for HTML files, Microsoft Word for RTF files, Adobe Acrobat Reader for PDF files.

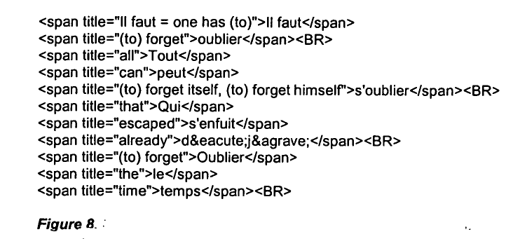

Three examples of manifestations are shown in FIGS. 8-11. In each of these manifestations, each word in the source document is uniquely assigned its own translation. FIG. 8 shows a manifestation using the built-in HTML tooltip-like feature (a “title” property of a “span” tag in this case), i.e., the HTML document source data contains underlying translation using the HTML tooltip.

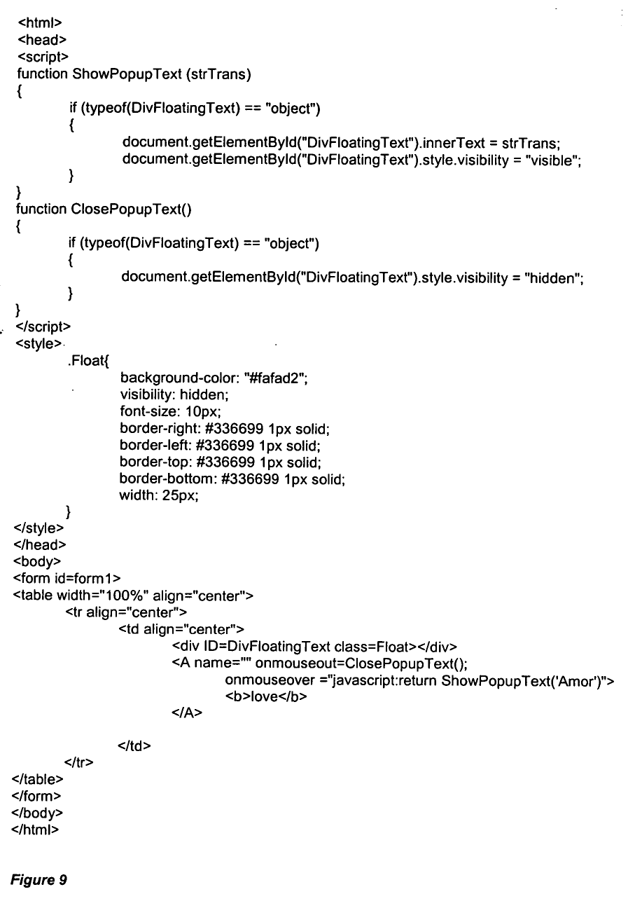

FIG. 9 shows another manifestation, again on HTML format, but using a Java script function, i.e., the HTML document source data that contains underlying translation using a pop up java script function.

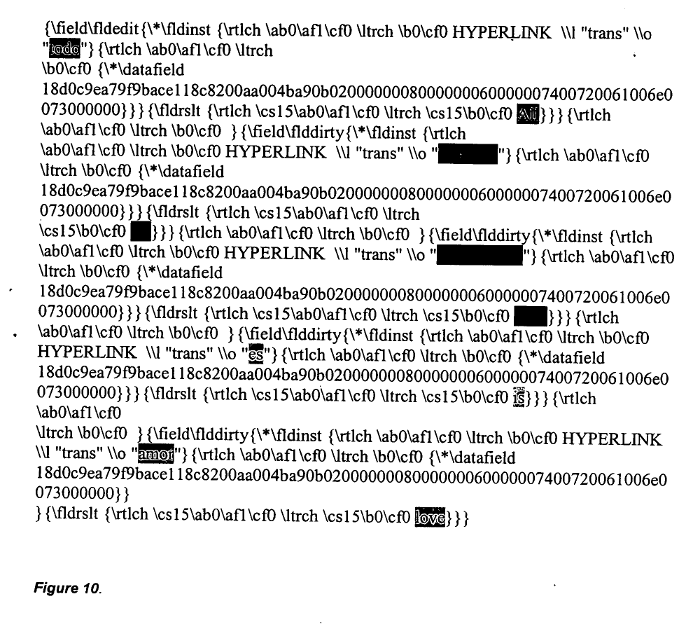

FIG. 10 shows a manifestation on RTF format, using psuedo-hyperlink tags, i.e., the RTF document source data that contains underlying translation using the existing hyperlink functionality of RTF files. The translations are entered as psuedo-hyperlinks, linking to a dummy bookmark, but displaying the translation as a hyperlink screen-tip. The translation will display when the mouse is hovered over the original language words. Words are colored for sake of demonstration.

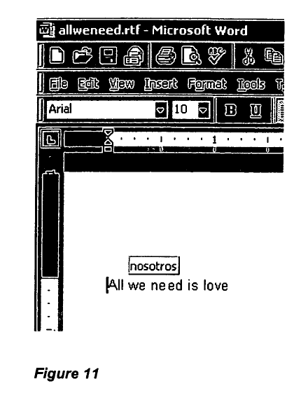

FIG. 11 shows how the same manifestation will show on the Microsoft Word application.

Implementation With Cross Language Search

The ETES model can also be applied in cross language search. A document in English language that contains a hidden layer with translation to French can be searched using French key words. For example, a French speaking user may search the Google (www.google.com) search engine for information that only appears in English documents. If these documents contain hidden translation to French, he or she can get the information using French key words. The query is translated to English, and the English results page created dynamically by Google is automatically processed for ETES, due to the user's language preferences; so the user can hover the mouse on the results and find out if they are relevant for him or her. If a result is relevant, he or she may use the link to it that will automatically include the embedded translation.

Commercial Significance

A user's reliance on a search engine to find results or an RSS reader to stay informed of the news, and also to translate them, has considerable implications on the commercial side. In effect, the search user does not have to leave the search engine as soon as relevant results are found, but keeps on getting the service from the server as he or she browses the Internet. This translation feature also provides a user with the ability to browse through the news while staying with the same RSS reader. Because the results that have the embedded translation layer are provided by the server, these pages can contain, for example, a header containing advertisements provided by the search engine or RSS reader; furthermore, the links from the pages with embedded translation can also contain embedded translation, so that the user will stay with the search engine or RSS reader for the duration of his or her web browsing; the commercial significance of this invention, then, for search engines and RSS readers is very high, and constitutes a departure from the way these products have operated so far.

The above description and drawings are only to be considered illustrative of exemplary embodiments, which achieve the features and advantages of the invention. Modification and substitutions to specific process conditions and structures can be made without departing from the spirit and scope of the invention. Accordingly, the invention is not to be considered as being limited by the foregoing description and drawings, but is only limited by the scope of the appended claims.

1. A search engine that produces search results comprising:
a visible layer containing text of an original language;
an invisible layer underlying said visible layer and containing translations of portions of said first language in a second language or languages; and
an association that connects portions of said visible layer to corresponding portions of said invisible layer, enabling exposure of a portion of said invisible layer, triggered by a user of the search engine, wherein a translation of said visible text is visible when said visible layer is displayed.

2. The search engine of claim 1, wherein said layered search results are produced by a search service provider server.

3. The search engine of claim 1, wherein said invisible layer comprises translations of portions of said first language comprising at least one word.

4. The search engine of claim 1, wherein at least some translations are context-sensitive.

5. The search engine of claim 1, wherein at least some translations contain morphological translations of inflections.

6. The search engine of claim 1, wherein said portion of said invisible layer is exposed directly over a corresponding portion of said visible layer.

7. The search engine of claim 1, wherein said portion of said invisible layer is exposed at a location which does not cover a corresponding portion of said visible layer.

8. The search engine of claim 1, wherein search results page includes links to versions of search result items that include a visible layer containing text of an original language, an invisible layer underlying said visible layer and containing translations of portions of said first language in a second language or languages and an association that connects portions of said visible layer to corresponding portions of said invisible layer, enabling exposure of a portion of said invisible layer, triggered by a user of the search engine, wherein a translation of said visible text is visible when said visible layer is displayed

9. The search engine of claim 1, wherein said user only selects a result that comprises said invisible layer.

10. A content subscription system comprising:
a visible layer containing a plurality of headlines of an original language, wherein said plurality of headlines correspond with user-selected content;
an invisible layer underlying said visible layer and containing context-sensitive translations of portions of said first language in a second language or languages; and
a link that connects portions of said visible layer to corresponding portions of said invisible layer, enabling exposure of a portion of said invisible layer, triggered by a user of the content subscription system, wherein a translation of said visible text is visible when said visible layer is displayed.

11. The content subscription system of claim 10, wherein the headlines are linked to articles that include a visible layer containing text of an original language, an invisible layer underlying said visible layer and containing translations of portions of said first language in a second language or languages and an association that connects portions of said visible layer to corresponding portions of said invisible layer, enabling exposure of a portion of said invisible layer, triggered by a user of the search engine, wherein a translation of said visible text is visible when said visible layer is displayed

12. The content subscription system of claim 10, wherein at least some translations are context-sensitive.

13. The content subscription system of claim 10, wherein at least some translations contain morphological translations of inflections.

14. The content subscription system of claim 10, wherein said invisible layer comprises translations of portions of said first language comprising at least one word.

15. A method of searching comprising the steps of:
retrieving a plurality of search results including text written in a first language;
translating through a processor in a server said text, portion by portion, to a second language or languages, wherein each portion contains at least one word;
inserting said translations into a data file; and
linking portions of text from a visible layer displaying said search results as text written in said first language to corresponding translations in said data file, wherein said data file is not visible.

16. The method of claim 15, wherein said step of translating said text includes morphologically analyzing each portion.

16. The method of claim 15, wherein said retrieving step is initiated by a user-activated search.

17. The method of claim 15, wherein said retrieving step is initiated by a content subscription system.

18. The method of claim 15, wherein said retrieving step is initiated by an RSS system.

19. The method of claim 15, wherein the portions of translated text are hyperlinks.

20. The method of claim 15, wherein the portions of translated text are web-content.

21. The method of claim 15, further comprising a step of making user-selected portions of translations in said data file visible.

22. A translation system comprising:
a server providing a page containing a plurality of hyperlinks in a first language; and
a processor in communication with said server, wherein said page comprises:
a visible layer containing a first text in said first language, wherein said first text describes said plurality of hyperlinks;
an invisible layer underlying said visible layer and containing translations of portions of said first text in said second language or languages;
a plurality of associations linking portions of said visible layer to corresponding portions of said invisible layer;
a selector for selection by a user of a portion of text on said visible layer of text; and
a display device for displaying a portion of said invisible layer corresponding to said portion of text on said visible layer of text.

23. The translation system of claim 22, wherein said page contains hyperlinks associated with search results from a user-activated search.

24. The translation system of claim 22, wherein said page is provided by an RSS reader.

25. The translation system of claim 22, wherein said page is provided as RSS feed.
